(19) United States
(12) Patent Application Publication
(10) Pub. No.: US 2012/0314630 A1
(43) Pub. Date: Dec. 13, 2012

(54) BROADCAST BAND SEGMENTATION STRUCTURES TO ENABLE BETTER UTILIZATION OF AVAILABLE SPECTRUM

(76) Inventors: Gordon Kent WALKER, Poway, CA (US); Xiaoxia ZHANG, San Diego, CA (US)

(21) Appl. No.: 13/494,963

(22) Filed: Jun. 12, 2012

Related U.S. Application Data
(60) Provisional application No. 61/513,863, filed on Aug. 1, 2011.
(60) Provisional application No. 61/496,553, filed on Jun. 13, 2011.

(51) Int. Cl. H04W 72/04; H04J 4/00; H04J 1/08

(52) U.S. Cl. 370/281; 370/312

(57) ABSTRACT

Systems and methods achieve higher spectral efficiency for broadcast networks based on grouping of band segments to enable effective reuse of radio frequency spectrum that enables realizable filters. This may involve co-location of transmitters for a specific group. The grouping of band segments can be applied in a broadcast architecture in which the broadcast market is served by a plurality of low-power, low height transmitters rather than a single high power, high transmitter antenna. By combining the benefits of grouping band segments with low-power, low-transmitter heights which exhibit shorter jamming ranges, further improvements in bandwidth utilization and availability can be achieved. Such a broadcast network may be deployed on transmission sites of existing cellular telephone networks. Embodiments may enable higher efficiency modulation schemes within existing land mobile formats including using higher order constellations that can be supported for mobile communications or using fixed reception specific mixed input/mixed output (MIMO) configurations.

### RELATED APPLICATIONS

This application claims the benefit of priority to U.S. Provisional Patent Application No. 61/496,553, entitled Broadcast Band Segmentation Structures to Enable White Space, filed Jun. 13, 2011, and U.S. Provisional Patent Application No. 61/513,863, entitled Broadcast Band Segmentation Structures to Enable Better Utilization of Available Spectrum, filed Aug. 1, 2011, the entire contents of both of which are hereby incorporated by reference.

### BACKGROUND

Wireless communication technologies have seen explosive growth over the past few years. Consequently, the demand for wireless bandwidth has been increasing. In order to provide more bandwidth to new wireless applications, many frequency blocks, such as analog TV spectrum, have been reallocated to new digital technologies. Also, increasing attention is being paid to the efficient utilization of available wireless spectrum. Efforts are underway to include more wireless communication within the same bandwidth. However, to avoid interference, many unused channels are provided between frequency blocks (channels) allocated to particular broadcasters in a given market. These unused or underutilized channels reduce bandwidth utilization, but are needed to enable reliable reception of transmissions in conventional broadcast networks.

### SUMMARY

The various embodiments include systems and methods for allocating frequencies in a multi-frequency broadcast network to enable effective reuse of radio frequency spectrum. Embodiment methods may include aggregating a number of broadcast frequencies into a continuous spectrum block comprising a broadcast group and allocating adjacent broadcast frequencies in the broadcast group to a plurality of broadcasters transmitting from a common transmission location or a virtually collocated transmission location. This may include creating more than one group of frequencies within a single market, and may include allocating guard bands to the outer edges of the broadcast group by removing internal guard bands between each of the adjacent broadcast signals when the broadcasters are transmitting Orthogonal Frequency Division Multiplex (OFDM) broadcast signals or other modulation schemes that are capable of operating with a zero guard band which are mutually orthogonal on a per signal basis. Embodiment methods may further include applying statistical multiplexing across multiple segments within the broadcast group, or using layered media coding to enable the multi segment utilizations with a requirement of multi-segment receivers to receive the entire signal or a single segment receiver to receive only the base signal. Embodiment methods may further include organizing frequency groups and segments to reduce adjacent channel filtering complexity in receiver devices, and may include allocating frequencies in an N-to-one (N:1) frequency reuse scheme, wherein N is a number between three and six. Embodiment methods may further include using upper and lower frequency regions that may be utilized as an frequency-division duplexing (FDD) pair with favorable duplex separation, which may include transmitting the signals of the plurality of broadcasters at relatively low power from a plurality of common transmission locations at relatively low antenna height within a second market approximately adjacent to the first market. Embodiment methods may further include transmitting signals within a plurality of frequencies groups at relatively low power from a plurality of common transmission locations at relatively low antenna height within a first market, which may include utilizing a first group of frequencies within the first market for television broadcast service, and a second group of frequencies within the first market for uses other than television broadcast. Embodiment methods may further include applying higher efficiency video coding to maintain or increase broadcast channels while reducing the aggregate baseband bandwidth consumed by such services and utilizing the increased spectrum using a method selected from the group of supplemental downlinks, carrier aggregation and multiple carrier methods. Embodiment methods may further include grouping one or both of contiguous and non-contiguous frequency groups and segments into one of supplemental downlinks and carrier aggregation. Embodiment methods may further include using low site low power spectrum in a frequency-division duplexing (FDD) pairing scheme, and organizing markets so that high density markets in an irregular plan receive more capacity. In various embodiments each of the plurality of frequency groups may be used for mixed communication services, which may contain television broadcast services in a different waveform, and the television broadcast transmissions may be mixed with one or both of cellular telephone transmissions and mobile broadband.

Further embodiments include a communication system having a transmitter site and a plurality of broadcasters transmitting from the transmitter site, in which the broadcasters are allocated adjacent broadcast frequencies in a carrier aggregated continuous spectrum broadcast group. Guard bands may be allocated to the outer edges of the broadcast group.

Further embodiments include a communication system having a first market including a first plurality of transmitter sites comprising antennas located at a relatively low height and configured to operate at a relatively low power compared to conventional broadcast television broadcast antennas, and a first plurality of broadcasters transmitting from each transmitter site, in which the first plurality of broadcasters are allocated adjacent broadcast frequencies in a carrier aggregated continuous spectrum plurality of broadcast groups, with guard bands allocated to the outer edges of the broadcast group. The communication system may further include a second market positioned approximately adjacent to the first market that includes a second plurality of transmitter sites comprising antennas located at a relatively low height and configured to operate at a relatively low power compared to conventional broadcast television broadcast antennas, and a second plurality of broadcasters transmitting from each transmitter site, wherein the second plurality of broadcasters are allocated the same adjacent broadcast frequencies in a same plurality of broadcast groups as in the first market transmitting from common transmission locations. In an embodiment, the communication system may include a single high height, high power broadcast television transmitter site, and a second plurality of broadcasters transmitting from the single high height, high power transmitter site, wherein the second plurality of broadcasters are allocated adjacent broadcast frequencies in a plurality of broadcast groups different from those in the first market transmitting from the broadcast television transmitter. Alternatively, the communication system may include a plurality of transmitter sites comprising antennas located at a relatively low height and configured to operate at a relatively low power compared to conventional broadcast television broadcast antennas, and a plurality of radio frequency users transmitting from each transmitter site, wherein the plurality of radio frequency users are allocated adjacent broadcast frequencies in a carrier aggregated continuous spectrum plurality of frequency groups transmitting from common transmission locations. The communication system may also include a plurality of adapter boxes coupled to a plurality of televisions and configured to enable reception of broadcast signals from the transmitters and provide received signals the plurality of televisions by an interface selected from an high-definition multimedia interface (HDMI) interface, an Internet protocol (IP) interface, and both an HDMI and IP interface.

In a further embodiment, a communication system may include means for aggregating a number of broadcast frequencies into a continuous spectrum block comprising a broadcast group and allocating adjacent broadcast frequencies in the broadcast group to a plurality of broadcasters transmitting from a common transmission location.

In a further embodiment a plurality of transmitter sites comprising antennas located at a relatively low height and configured to broadcast at a relatively low power compared to conventional broadcast television broadcast antennas, and means for allocating adjacent broadcast frequencies in a carrier aggregated continuous spectrum broadcast group to a plurality of broadcasters transmitting from each of the plurality of transmitter sites.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating broadcast communication systems sharing a single broadcast transmission site.

FIG. 2 effects of transmission and a low noise amplifier (LNA) upon unused band segments or channels.

FIG. 3 illustrates effects of frequency spreading resulting in potentially no useful spectrum in a three in one frequency reuse multi-frequency network.

FIG. 4 illustrates the out-of-band emission mask permitted for digital television DTV under the FCC Memorandum Opinion and Order on Reconsideration of the 6th Report and Order, Released Feb. 23, 1998.

FIG. 5 is an illustration of the benefits of grouping broadcast frequencies according to the various embodiments and a filter scheme suitable for use in such an embodiment.

FIG. 6 is an illustration of the benefits of grouping broadcast frequencies according to various embodiments and a second filter scheme suitable for use with the embodiments.

FIG. 7A is an illustration of the benefits of grouping broadcast frequencies according to various embodiments and a third filter scheme suitable for use with the embodiments.

FIG. 7B is an illustration of a frequency allocation solution for irregular spectrum as present in United States markets.

FIG. 8 illustrates three adjacent markets each including a plurality of networks with two of the markets implementing low power low site networks and one market implementing a high power network according to another embodiment.

FIG. 9 includes a graph of signal strength versus distance and illustrates how an edge required channel to noise ratio can define a jammed area relative to the served area.

FIG. 10A illustrates how successive rings of low-power transmitters positioned around a center cell of a low powered transmitter causes an expansion of the coverage area and opened edges.

FIG. 10B illustrates the difference in jam area between a low power low site network market and a high power single site network.

FIG. 11 is a table illustrating how the number of transmitters grows as additional rings of transmitters are added to a market in a low-site, low-power network deployment.

FIG. 12 is a table of approximations of the ratio of jammed area-to-served area in a low-site, low-power network deployment according to an embodiment.

FIG. 13 is a table of calculation results for the case of the 8:1 served versus interference region in a high site, high power network deployment.

FIG. 14A is a frequency planning model for frequency band allocations in a 4:1 frequency reuse scheme for high-power networks.

FIG. 14B is an illustration of an example frequency allocation plan for 16 adjacent high power high site markets based on a 4:1 frequency reuse scheme illustrated in FIG. 14A.

FIG. 15A is a frequency planning model for frequency band allocations in a 4:1 frequency reuse scheme, which includes allocations for low-power networks designated as frequency segments AB.

FIG. 15B is an illustration of an example frequency allocation plan for 16 adjacent markets including a column of low-site, low-power network markets based on a 4:1 frequency reuse scheme illustrated in FIG. 15A.

FIG. 16 is an illustration of an example frequency allocation plan for 16 adjacent markets that includes two columns of low-site, low-power network markets based on a 4:1 frequency reuse scheme illustrated in FIG. 15A.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “receiver device” refers to any one or all of cellular telephones, mobile multimedia receivers, personal television receivers, mobile television receiver devices, personal data assistants (PDA's), palm-top computers, lap-top computers, wireless electronic mail receivers (e.g., the Blackberry® and Treo® devices), multimedia Internet enabled cellular telephones (e.g., the Blackberry Storm®), Global Positioning System (GPS) receivers, similar personal electronic devices which include a programmable processor and memory and broadcast and/or cellular network receiver circuitry for receiving and processing wireless broadcast transmissions, televisions, set top boxes, radio receivers, and/or other devices configured to receive wireless broadcast transmissions.

The word “broadcast” used herein may include the transmission of data (information packets) so that it can be received by a large number of receiving devices simultaneously, and/or any other types of broadcasts.

The various embodiments are useful with a variety of broadcast and unicast technologies. In particular, the embodiments may be useful with new broadcast technologies, such as mobile TV broadcast technologies. A number of mobile TV technologies and related standards are available or contemplated in the future, all of which may implement and benefit from the various embodiments. Such standards include Open Mobile Alliance Mobile Broadcast Services Enabler Suite (OMA BCAST), MediaFLO, Digital Video Broadcast IP Datacasting (DVB-IPDC), China Multimedia Mobile Broadcasting (CMMB), ISDB-T, ATSC, ATSC-M/H, DVB-T2 and DVB-T standard networks. The embodiments, however, need not be limited to mobile TV broadcast technologies and may be used in connection with other broadcast TV and/or radio technologies, including, but not limited to, those within the various ATSC, DVB, ISDB and/or other standards.

In order to enable wireless receiver devices to receive a given transmission within one frequency band, frequency allocation schemes typically use guard bands on either side of that frequency band to avoid interference from other transmitters. Such guard bands and other underutilized bandwidth represent bandwidth that is not otherwise typically being utilized, except to solve the interference problem posed by adjacent broadcast bands or co-channel interference. Such underutilized bandwidth is of interest to new radio technologies known as whitespace radio or conventional land mobile communications, which have the potential to make use of this bandwidth.

In order to make the best use of the available bandwidth, spectrum users collaborate in plans for allocating spectrum blocks among various broadcasters and wireless service providers within various service markets. Since radio transmissions have limited range, frequency blocks can be reused across a wide geographic area. The typical frequency planning regimen of broadcast television often results in adjacent channels being utilized by adjacent markets. For example, in the San Diego market, broadcasters may be allocated channel 35, while in the Los Angeles market broadcasters may be allocated channel 34. While this frequency allocation scheme appears reasonable, it may result in a high power signal immediately adjacent in frequency to a nominally unoccupied channel. This “unoccupied” channel may thus be unfortunately subject to high levels of interference due to non-linearity of the low noise amplifier of a receiver attempting to receive the signal within the adjacent channel or whitespace or the out of band energy of the high power network.

Current frequency reuse patterns of network planning for broadcast TV and radio substantially makes the use or reuse of so called whitespace frequency impractical or inefficient. This impracticality is due to the current frequency allocation scheme which separates the active transmission brands by large guard bands, thus sprinkling the active transmission bands across the entire broadcast spectrum. Due to the nonlinear effects of receiver devices as well as distortions in the transmission path, this current allocation scheme results in a vast amount of the underutilized frequency spectrum allocated between active transmission bands that is unavailable for any use due to the high level of interference from the active transmission bands. As a result, it is difficult use or reuse the unoccupied channels on either side of the high-power transmission bands (i.e., frequency bands adjacent to high power transmission bands).

This typical frequency allocation scheme also presents difficulty for receiver device manufacturers, because the realizable receiver architectures require significant attenuation of nominally out of band signals. In order to receive signals from a given broadcaster in such a frequency allocation scheme, the receiver devices are equipped with a large number of very narrow band filters, which are generally unrealizable with existing technology.

These problems can be resolved by changing the manner in which frequency planning is organized. In particular, the various embodiments involve grouping active transmission bands together in a block with little or no guard bands in between when the broadcast are all transmitted from a single transmission site. Single transmission sites are common in many large metropolitan markets, so deploying the embodiments in traditional high-power, high-site transmission sites may involve simply changing frequency allocations. This approach provides a large amount of spectrum outside of the grouped together transmission bands, which can enable filter configurations for receiver devices that are easier to manufacture within current technologies. There are several classes of receivers that are possible with reasonable complexity when the embodiment frequency band planning structures are implemented.

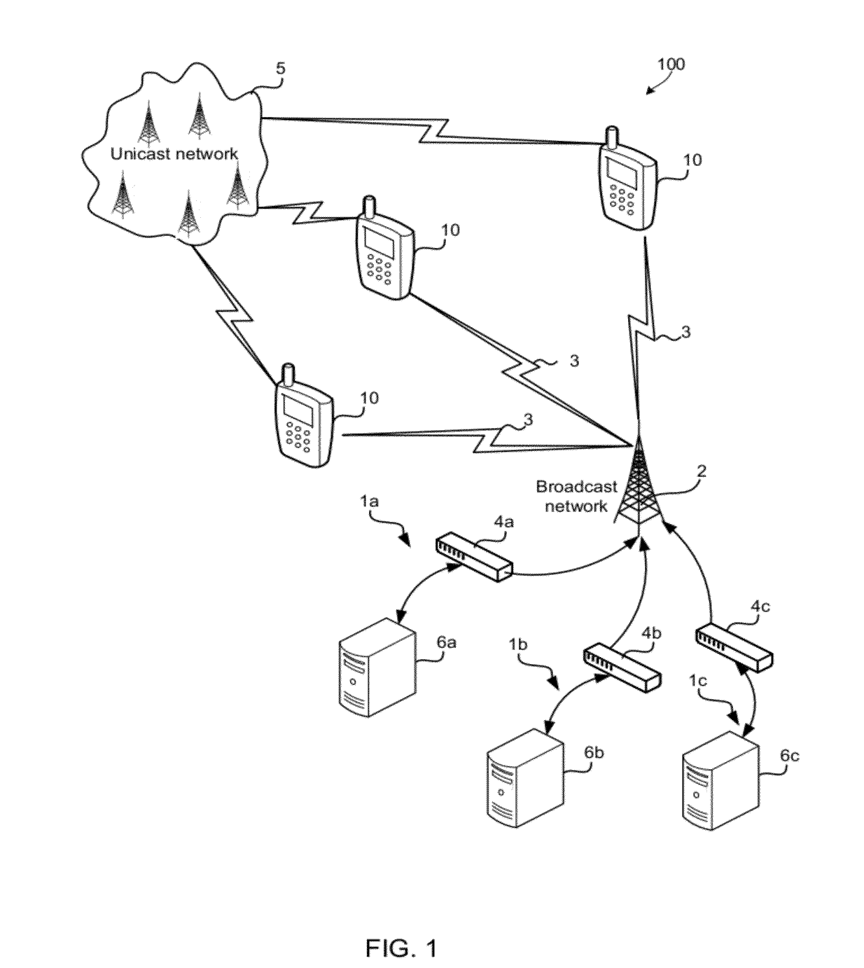

Example components of a broadcast system 100 that may be useful for illustrating the various embodiments are illustrated in FIG. 1. Multiple broadcast networks 1a, 1b, 1c may share a common transmission site 2, such as a large transmission tower or a tall building within a particular wireless services market. Each of the plurality of broadcast networks 1a, 1b, 1c may be controlled by a respective network control center 4a, 4b, 4c coupled to their respective content sources 6a, 6b, 6c. The broadcast signals may be transmitted by a transmission amplifier associated with each broadcast network or may be run through a single high-power amplifier, or multiple separate amplifiers and then combined. Wireless transmissions 3 emanating from the same transmission tower 2 from each of the broadcast networks 1a, 1b, 1c may be received by any number of receiver devices 10. Many types of receiver devices 10 may also be configured to send and receive wireless transmissions from a network 5 (for instance a unicast network, such as a cellular telephone network, a Wi-Fi network, etc); however, the receiver devices 10 need not be configured to send and receive wireless transmissions from the network 5. Some or all of these wireless networks may be capable of transmitting the content within the available bandwidth so that receiver devices 10 can receive any one particular transmission without interference from others.

In an implementation detail, if the various broadcast signals are put in-segment through a single power amplifier and filter, which would be very high power amplifier, the resulting signal would have broad shoulders. However, if such signals are combined together in such a manner, the existing filters of transmission systems can roll off (i.e., filter out) the shoulders such that the resulting combined broadcast signal within the broadcast group does not have inordinately broader shoulders, and thus does not span a greater amount of the adjacent frequency spectrum. Typically the individual transmitters and filters would be retained as they are today, and combined. This is already done in places like New York City where several stations sharing a high power antenna.

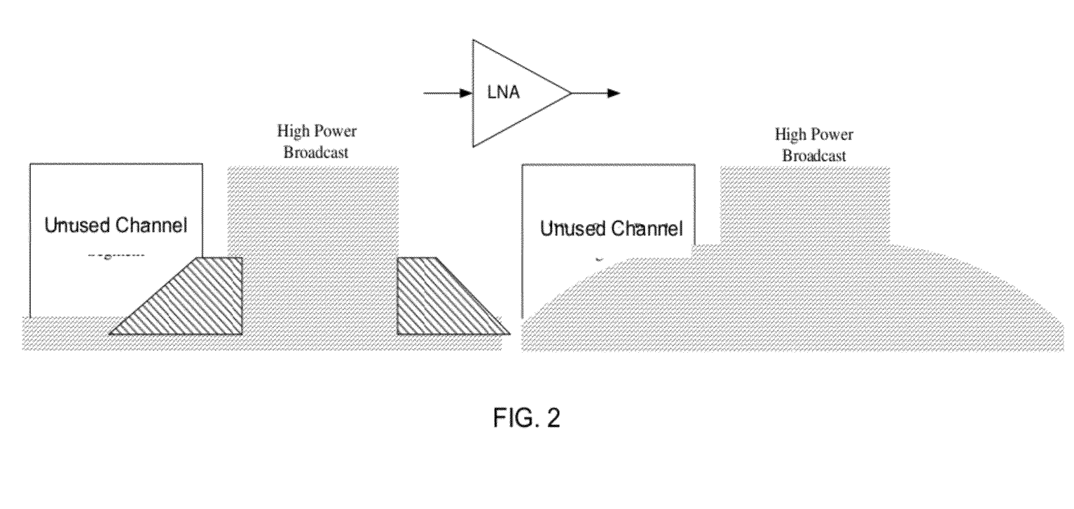

The problem of current frequency allocation schemes can be understood with reference to FIG. 2. As this figure illustrates, the nonlinear effects of the low noise amplifier in a whitespace receiver device can result in the appearance of a significant amount of interference in the normally unoccupied channels adjacent to a high-power broadcast band. FIG. 2 shows how a one-in-three broadcast spectrum reuse scheme results in no useful spectrum in a 3:1 frequency reuse MFN network, since the interference band encompasses all of the spectrum between each high-power broadcast band. As a result, the many of the unused channels are generally not usable, such as by whitespace receiver devices or land mobile devices.

One solution to this problem is to insert a narrow band filter ahead of the low noise amplifier within a whitespace or land mobile receiver in order to reduce the level of the undesired out of band signal. However; when the number of channels becomes large, and/or the individual bandwidths are relatively narrow, the filter required for this purpose becomes unrealizable, and a large number of filters are required. For example, in the current US UHF frequency band there are 38, 6 MHz segments. Using thirty-eight 6 MHz wide filters with the necessary frequency stability in receiver devices is beyond the affordable technologies.

The various embodiments may provide a solution to this problem, obviating the need for an individual filter per frequency band, by grouping together the carriers in a given market into a block of channels. In many markets, this is a reasonable solution, because the broadcast transmitters are generally collocated on a few tall structures in each market. For example, in New York City many broadcasters are located on a single building in Times Square. A second substantial group of stations is located on the nearby Empire State Building. Further, the nominal in-band guard bands between the high power broadcast signals may essentially be eliminated, if desired. This is made possible because the path loss from the primary sites, so called macro shadowing, is correlated enough to allow Orthogonal Frequency Division Multiplex (OFDM) waveforms to be set immediately adjacent to each other. In other words, a single raster of OFDM carriers may be utilized across nominally the entire assigned bandwidth. Similarly, favorable results may be achieved with single carrier waveforms such as ASTC, however at somewhat lower overall spectral efficiency.

Utilizing such a structure enables a number of other potential efficiencies in terms of statistical multiplexing across radio segments. Frequency space may be divided into M channels, as is typical, either 5, 6, 7, or 8 MHz each. The channels in a given market or service area may be organized in groups of N adjacent or nearly adjacent channels. Ideally, M/N is an even integer number if the goal is symmetric frequency-division duplexing (FDD) whitespace organization. However, this is not essential and M/N may be an odd integer or irregular organization.

A practical consequence of the embodiment frequency allocation approach is to make the use of dedicated filters possible in land mobile receiver devices. This is because the high-power transmission bands are grouped together, thereby leaving a large amount of unoccupied spectrum on either side of the high-power transmission bands. In other words, the guard bands that would normally be placed between the high-power transmission bands can be reallocated to frequency bands outside the group of broadcast frequencies. This greater amount of spectrum between high-power broadcast bands enables the use of a number of filters exhibiting broader frequency coverage. Such broad frequency coverage filters may be implemented in an overlapping fashion to provide the necessary filtering with a smaller number of lower cost, technology-achievable filters. So, while the whitespace or land mobile receiver low noise amplifier still exhibits a nonlinear behavior, the level of the undesired signals can be reduced significantly in a large percentage of the spectrum between the groups of high-power transmission bands.

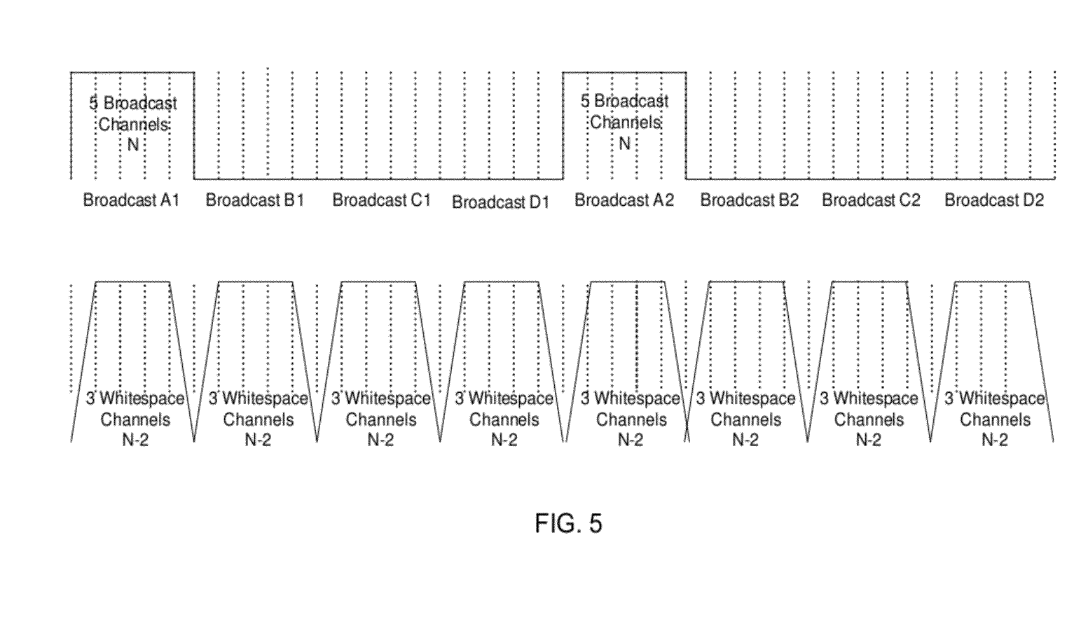

The various embodiments enable a variety of different types of frequency allocation schemes and receiver device filter configurations. FIG. 5 illustrates an exemplary frequency allocation plan based on a four-to-one broadcast frequency reuse scheme nominally based on 5 MHz wide channels. There are two reasons for shape of the broadcast spectrum; the out of band emissions of the broadcast transmitter, and the channel effects within the front end electronics of the receiver. FIG. 5 illustrates a filter scheme in which one channel guard band on either side of each of the active broadcast allocations is used to allow for reasonable transition bands for the whitespace or land mobile receiver. As this figure illustrates, this embodiment results in 40% of the potential whitespace bandwidth being allocated to guard bands. While this embodiment implements a number of filters, each filter can be designed to address five of the 5 MHz transmission bands. This filter design is much easier to implement than requiring a filter for each of the 5 MHz bands.

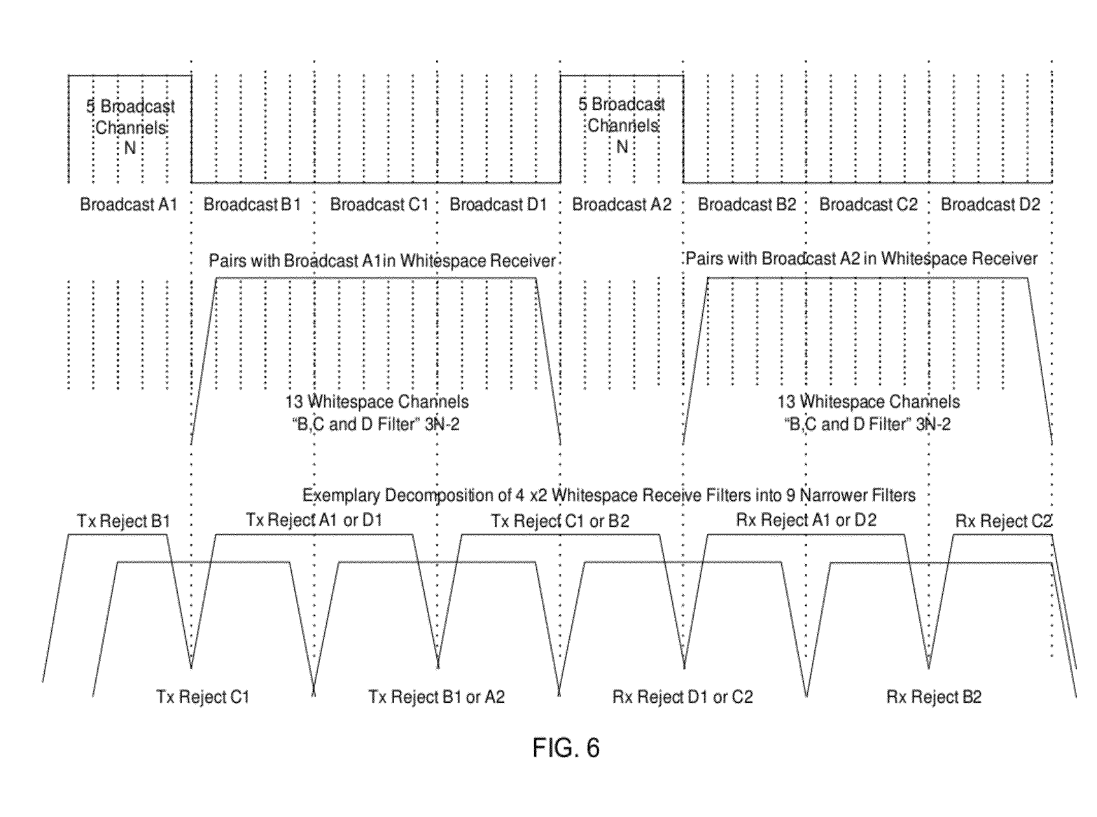

Another frequency allocation and filter configuration scheme is shown in FIG. 6. In this embodiment, a receiver recovers most of the mid-band whitespace channels by using multiple overlapping filters. As illustrated in the figure, this embodiment requires only one net additional filter. Selection of an approach utilized for a particular receiver may be dictated by filter realizability (i.e., the bandwidth and frequency stability achievable in the filters) and the numerology of the selected frequency band structure. With the overlapping filter approach illustrated in FIG. 6, the fraction of potential spectrum devoted to guard bands is reduced to 13.3% in this example.

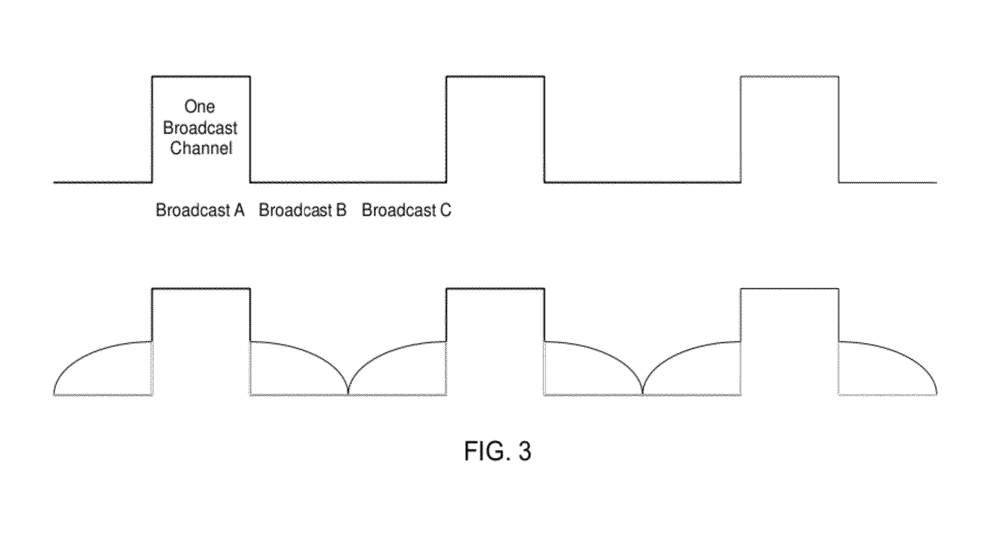

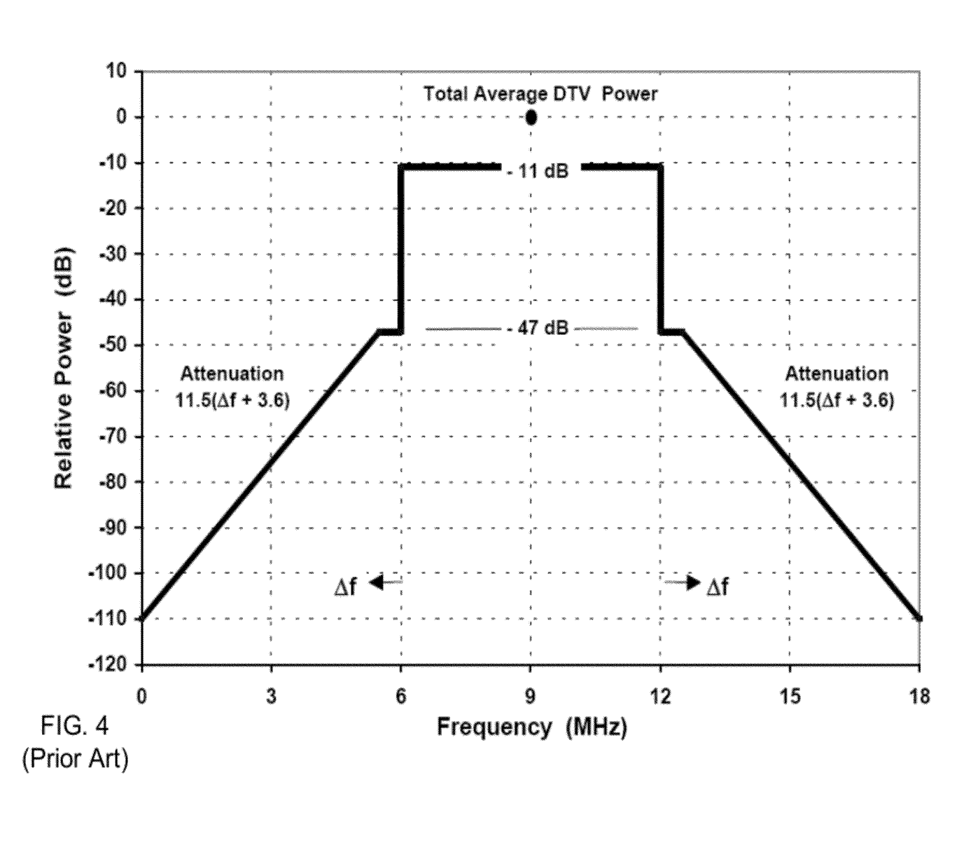

The roll off in signal amplitude in frequencies adjacent to assign frequency blocks illustrated in FIG. 3 is due in part to FCC regulations of the spectral density distribution of television channel signals. FIG. 4 illustrates the acceptable emission power mask as permitted by FCC regulations.

The various embodiments are also applicable to a variety of frequency schemes. Broadcast TV is organized in many parts of the world according to a 6 or 8 MHz raster scheme, while WCDMA and LTE utilize a 5, 10 or 20 MHz raster scheme. While compacting the broadcast TV signals into adjacent frequency bands to operate with zero guard bands on a 5 MHz raster regains some bandwidth as described above, conventional signals may be supported via similar frequency plans. For example 3×8 MHz and 4×6 MHz are each 24 MHz in width. Therefore, three or four broadcast TV signals may be used in each 24 MHz band, which nominally supports five×5 MHz channels. Five×6 MHz yields 30 MHz per broadcast allocation, but this requires 240 MHz for a four to one frequency reuse scheme, which is a bit more than potentially available in the US, so 24 MHz organization may be more reasonable. In accomplishing this configuration, the carriers may be orthogonal signal formats, such as OFDM. Most signals that accomplish zero guard band are OFDM. However, it may be possible to configure the 5-8 carriers such that they are five OFDM carriers.

As shown in FIG. 5 the whitespace frequency may be organized in nominally 5 MHz rasters with actual bandwidth set to 4.8 MHz. This organization may place more stringent requirements on the whitespace receivers and/or the deployment style of the wide area network (WAN). A less efficient scheme from a spectral reuse perspective is also shown in FIG. 5 which a 5 MHz channel is maintained and the guard band segments are allocated 4.5 MHz each.

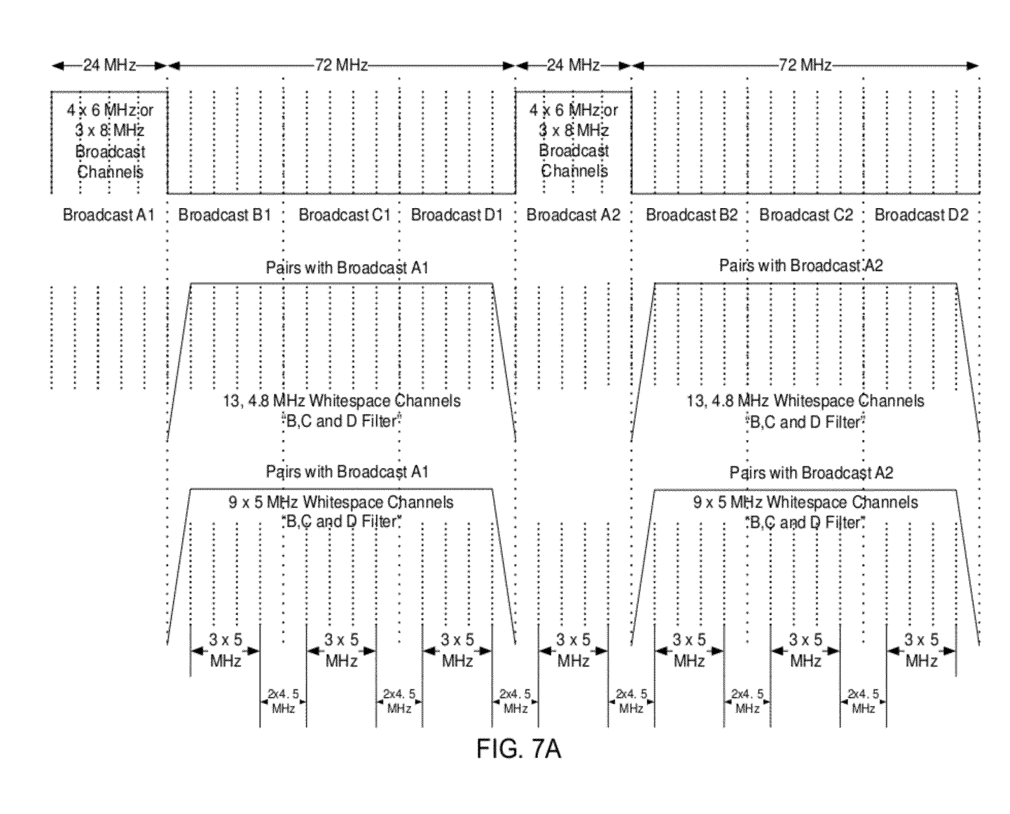

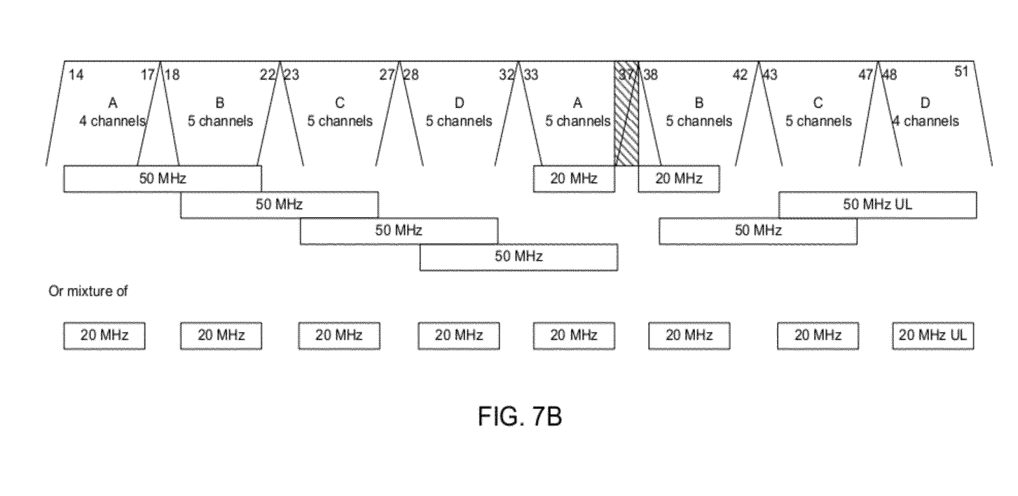

A variety of filter combinations and configurations that may be utilized in whitespace receiver device are illustrated in FIGS. 5-7A. The embodiments enable receiver devices to be configured with wideband filters that do not require a narrow transition. Such receiver devices can nominally recover the spectrum in the markets where this spectrum allocation scheme is implement without requiring a different organization of filters, such as 10 filters as shown in the middle part of FIG. 4. For example, when the receiver device is configured to receive signals in the D block, it includes covering the C block as illustrated in FIGS. 6 and 7A.

FIG. 7B illustrates an exemplary solution for the irregular spectrum that is present in the U.S. and other markets due to the nonuse of channel 37. Channel 37 is an unused television channel in countries using the M and N broadcast television system standards. Channel 37 occupies a band of UHF frequencies from 608 to 614 MHz, frequencies that are particularly important to radio astronomy. For this reason, Channel 37 is not used by any over-the-air television station in Canada or the United States. As illustrated in FIG. 7B, the a filter solution can be provided by mixing channel 4 and channel 5 blocks, and reassigning the spectrum to land mobile applications, such as for low height tower and low power transmitters as use in cellular telephone networks.

The use of fixed, limited-channelization for TV broadcast can have an adverse impact on achieved broadcast capacity. This is caused by the potential for a relatively wide band multiplex stream being carried in a relatively narrow bandwidth. For example, a 13 Mbps peak high definition (HD) stream in a 6 MHz channel, which can carry a maximum of ˜20 Mbps (for ATSC), results in a limit of one HD stream per channel. If two band segments are combined, then 3 HD signals could be carried in the two adjacent band segments with fixed multiplexing.

The benefits of statistical multiplexing can be achieved, for instance, if the number of aggregated video services exceeds 5 in the accessible bandwidth. In this context, “accessible” indicates the number of radio frequency (RF) channels that are concurrently decodable by the deployed receivers. While increasing the operating bandwidth beyond 5 MHz does not substantially increase the performance of the physical layer due to frequency diversity, increasing the multiplex bandwidth may significantly increase the number of supportable channels. This is particularly the case if a more efficient video codec such as H.264 or H.265 is utilized.

The use of layered coding may be applied in conjunction with the embodiment frequency sharing schemes. In this embodiment, the base layers of all services may be placed in their home segment, and the enhancement layer(s) may be placed in other segment(s). The use of layering allows the multiple frequency segment reception to be optional.

Assuming that layering is not optional, the receiver must support as many segments as exists within the desired service. The number of segments utilized forms a limit on the maximum allocatable baseband bandwidth that is available for a service. This may place some special constraints on the statistical multiplexer, as services with their home segment 1 and share segment 2 must receive all content broadcast in segments 1 and 2. This general concept may be expanded to more segments.

Exemplary planning from mobile MTV networks may include the following parameters. The typical TV broadcast network planning is predicated on outdoor reception at 9 or 10 meters in height. The nominal planning for mobile services is predicated on indoor reception at a height of 1.5 meters. Television broadcast typically utilizes a directional antenna of 12 to the 13 dBi gain. The typical mobile receiver has a omni-directional antenna of less than 0 dB efficiency typically less than −3 dB. The typical land mobile device has its antenna effectively attached directly to a receiver with a 6 to 7 dB noise figure. The typical television receiver may have an input noise figure for UHF in the range of 9 to 10 dB. The antenna may have a feed loss of typically 2 dB so the effective system noise figure is 11 to 12 dB. Mobile communication systems can often support communication at 0 dB C/N. Television systems are in general operated at around 16 dB C/N.

Considering the aggregate effect of these attributes allows a comparison of the required received signal strengths for the two respective systems. Based on this simplified analysis, it is fairly easy to observe that the FCC edge of contour receive signal strength of 41 dB uV is realistic. There are other notable observations. The typical field strength for broadcast at the edge of coverage, when adjusted for height, is below the effective noise of the mobile receiver device. As a result, the mobile device could operate essentially to the edge of coverage of the television network. Conversely, the required level for the mobile device (outdoors reception) may be significantly above the effective noise floor for the television terminal.

Some parameters applicable to the various embodiments are summarized in Table 1 below.

TABLE 1

| Parameter | ATSC | Mobile | | Notes |
|---|---|---|---|---|
| Noise Figure | 7 | 7 | dB | OET 69 |
| Feed Loss | 4 | 0 | dB | OET 69 |
| Effective NF | 11 | 7 | dB | |
| System | 298 | 298 | K | |
| Temperature | | | | |
| Boltzman's | 1.4E−23 | 1.4E−23 | J/K | |
| Constant | | | | |
| Noise Bandwidth | 5.38 | 4.5 | MHz | |
| System Temp | 2.2E−14 | 1.9E−14 | W | |
| Noise Power | | | | |
| System Temp | −106.6 | −107.3 | dBm | |
| Noise Power | | | | |
| Receiver Input | −99.6 | −100.3 | dBm | |
| Noise | | | | |
| Required C/N | 16 | 0 | dB | |
| Antenna Output | −79.6 | −100.3 | dBm | |
| Level | | | | |
| Antenna Gain | 12.14 | −3 | dBi | OET 69 |
| Frequency | 615 | 615 | MHz | |
| Level Offset | 10.1 | 10.1 | dB | Hata suburban |
| for Height | | | | for level offset |
| Field | 41.3 | 45.8 | dBuV/m | |
| Strength 10 m | | | | |
| Field | 31.2 | 35.7 | dBuV/m | |
| Strength 1.5 m | | | | |
| Noise Floor as | 25.3 | 35.7 | dBuV/m | At receive height |
| Field Strength | | | | |

The practical consequence of the embodiments is that the required field strength of the mobile network may be substantially higher at the edge of coverage than that of the television network. The simplistic analysis did not consider two additional items that are typically part of a conventional network design, penetration loss and margin for log normal shadowing. These two terms in aggregate are less than 20 dB at the edge of mobile coverage, 10 dB penetration, and 10 dB log normal shadowing margin.

As discussed above, the foregoing frequency allocation methods of grouping broadcast peers together provides substantial increase in the amount spectrum available for frequency users other than the high-power broadcasters. The same concepts can be implemented in a new broadcast architecture which can further increase the amount of spectrum available for all uses by reducing the regions of jamming. This new broadcast architecture replaces single or few high-power transmission towers with a large number of low-power relatively low height transmission towers. Traditional television broadcasts are transmitted from tall towers or from the tops of buildings and at high broadcast power (referred to herein as “high-power, high site”). The new architecture transmits the same television signals deployed together as described above from large number of relatively short transmission towers (referred to herein as “low-power, low-site”) with much lower broadcast power. As described below, low-power, low-site transmitters exhibit a much reduced size of their interference area (i.e., the area surrounding each transmission tower at which the broadcast transmission signal strength exceeds the level which can interfere with other wireless communications but is less than that sufficient to enable reception). By using a large number of such low-power, low-site transmitters within a given market, the interference area around the edge of the market is much smaller than is the case for a single high-power high-site transmitter serving the same market area. The combination of frequency planning and deployment style changes between broadcast and unicast applications may make available a net increase in the available bandwidth in all applications that can be shared.

The low-power, low-site transmitter network architecture is illustrated in FIG. 8 which shows three adjacent markets A, B, C. Markets A and B are configured according to the low-power, low-site architecture while market C is a conventional high-power, high site architecture. All of the transmitters in markets A, B, C may implement the frequency grouping embodiments described above. As illustrated, the low-power, low-site transmitters 82 and 84 in each of markets A and B are deployed in a cellular structure so that the coverage areas (i.e., the area in which the signal strength equals or exceeds the minimum for reception of the broadcast) overlap. This contrasts with the traditional architecture implemented in a market C in which a single or few high power, high site transmitters broadcasts at sufficient power, so that the service area encompasses the entire market.

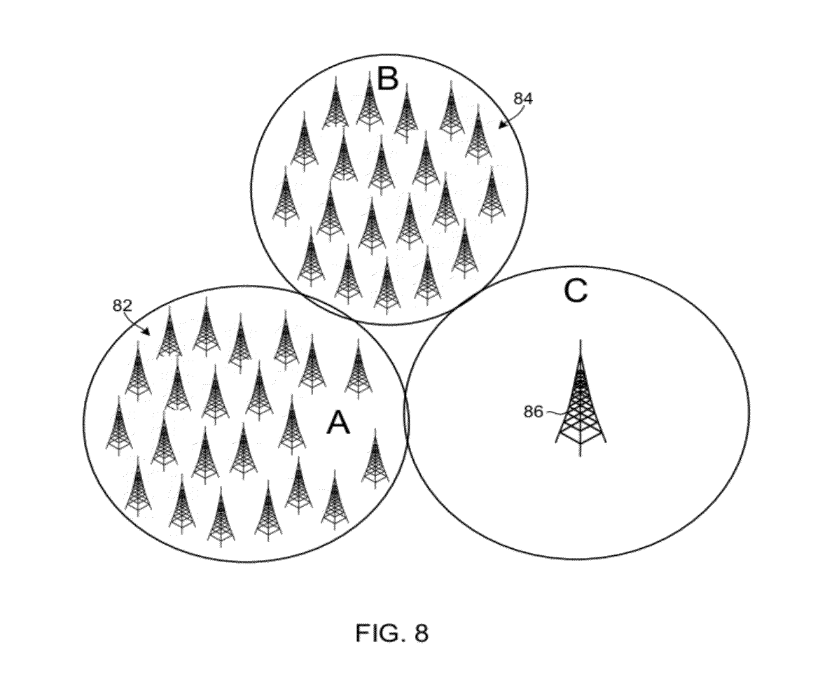

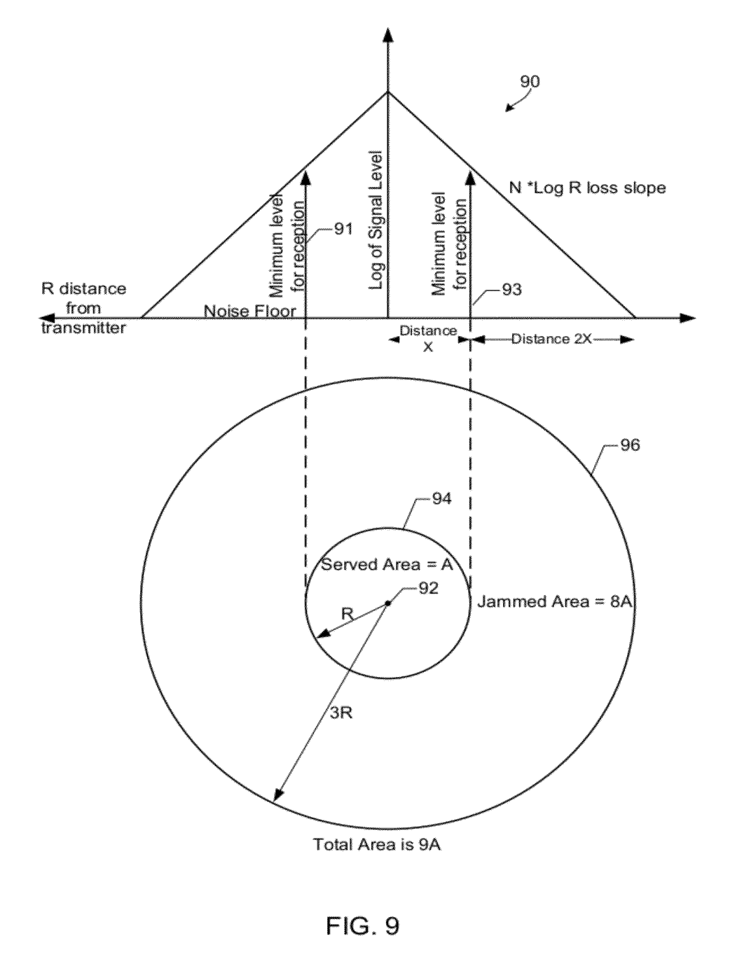

The advantage of implementing the various embodiments in some markets can be appreciated by considering the geometric relationship between the served area around each transmitter compared to the jammed area. This is illustrated in FIG. 9 which in the top portion includes a graph 90 of the log of the signal level as a function of distance from the transmitter 92. Immediately surrounding the transmitter 92, the signal strength is sufficiently high so that receiver's can reliably receive the broadcast. However, due to the reduction signal strength with distance, at some distance from the transmitter, the signal level reaches the minimum for effective reception. This point is indicated by the vertical arrows 91, 93. The transmitted signals extend far beyond that range with the signal strength declining as a function of 1/R² (approximately), until the signal strength equals the acceptable noise floor of other users of the frequency bands.

The distances about the transmitter to the point of minimum level for reception defines a circle 94 (in ideal circumstances). The region beyond the served area 94 extends to the distance at which the signal strength reaches the noise floor, which is indicated by the circle 96. As illustrated in FIG. 9, if the served area has a total area of A, the jammed area will have an area of approximately 8 times larger, or 8A. FIG. 9 also illustrates an approximate relationship between the radius of the served area and the radius of the jammed area. For frequency planning purposes, if the served area has a radius R, the jammed area may have a radius three times larger, or 3R. These relationships are approximate and based on assumptions, but sufficient for planning purposes.

FIG. 9 also illustrates a basic principle of frequency planning applicable to the various embodiments that adjacent markets cannot reuse the same frequency, due to the jammed area overlapping. Consequently, markets using the same frequency bands must be separated by a distance equal to three times the radius of each market in the case of a single or few high-power, high site transmitters. The same principles apply to the low-power, low-site architecture. However, the jammed area radius around each low-power, low-site transmitter 92 will be a small fraction of the radius of the overall market if the number of such transmitters in the market is large. Thus, the jammed area extending beyond an edge of a market in the low-power, low-site architecture will be much smaller than that of a high-power, high site network market. As a result, low-power, low-site network markets using the same frequency blocks may be positioned much closer together than conventional high-power, high site network market which requires that markets reusing frequency bands be separated by three times the radius of the markets.

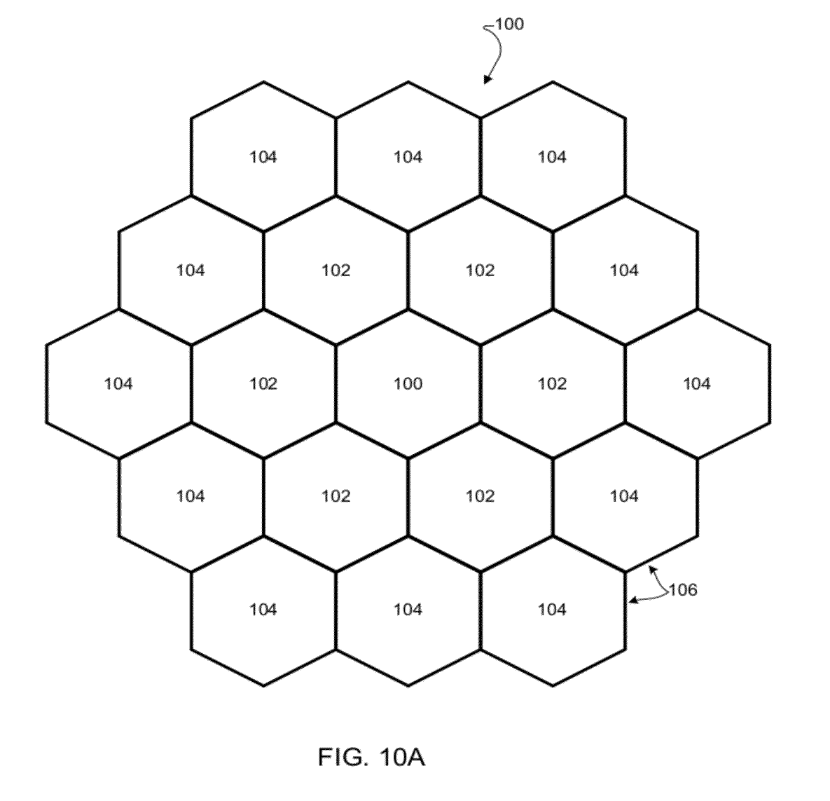

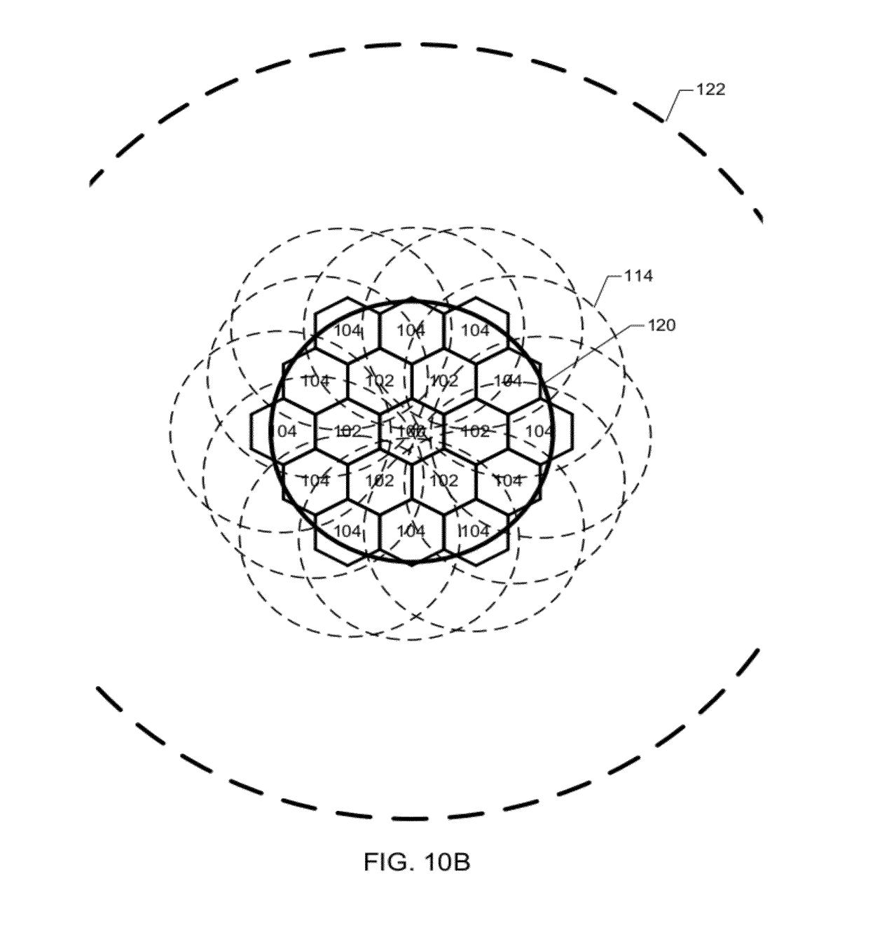

When these simple geometric concepts are combined with the frequency grouping embodiments described above, the result is a much larger reusable frequency bandwidth across multiple markets. This result can be appreciated by considering FIGS. 10A and 10B. FIG. 10A illustrates an example market 100 made up of a plurality of transmitters defining a plurality of coverage areas 100, 102, 104. In this ideal symmetric deployment, a central served area cell 100 is surrounded by two rings of served areas 102 and 104 to encompass the entire market area. This deployment is for illustration purposes only, since transmitters and served area cells are likely to be arranged less symmetrically, as deployment sites will be dictated by the local attenuation characteristics of surrounding buildings and geography (e.g., hills and valleys). Thus, in some regions (e.g., in cities with closely spaced buildings) transmitters may be located closer together to accommodate local signal attenuation than transmitters, which may be positioned on hilltops where they can yield larger served areas.

Since the jammed area is centered on the transmitter within each served area cell, the extent to which the jammed area extends beyond the market 100 is defined by the edges 106 of those served area cells that are positioned about the periphery of the market. Using the rough relationship between served area and jammed area illustrated in FIG. 9, the jammed area extends approximately two times the radius of each served area cell along the perimeter of the market. This is illustrated in FIG. 10B, which shows in dashed lines the extent of the jammed area 114 about each served area cell positioned around the market periphery. For purposes of comparison, the served area of a comparably sized high-power, high site architecture market is illustrated by the dark circle 120. Dashed circle 122 illustrates the approximate extent of the jammed area for the conventional high-power, high site architecture market. The area encompassed by the outer periphery of the low-power, low-site architecture jammed area 114 is much less than the area encompassed within the jammed area 122 of the high-power, high site architecture market. The area between the outer periphery of jammed areas 114 of the low-power, low-site network market and the jammed area 122 around the high-power, high site network market represents areas where the frequency bands allocated to the market 100 can be reused without jamming.

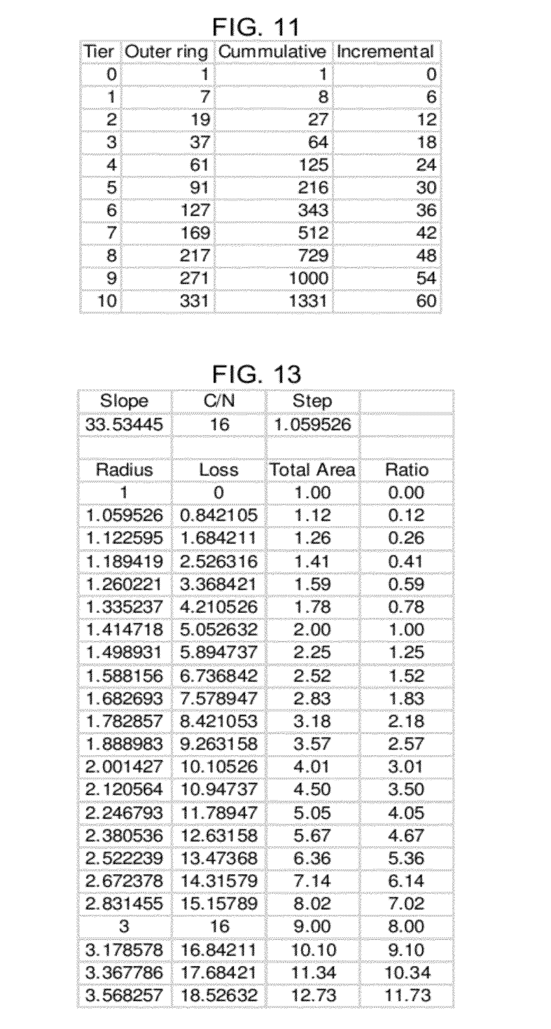

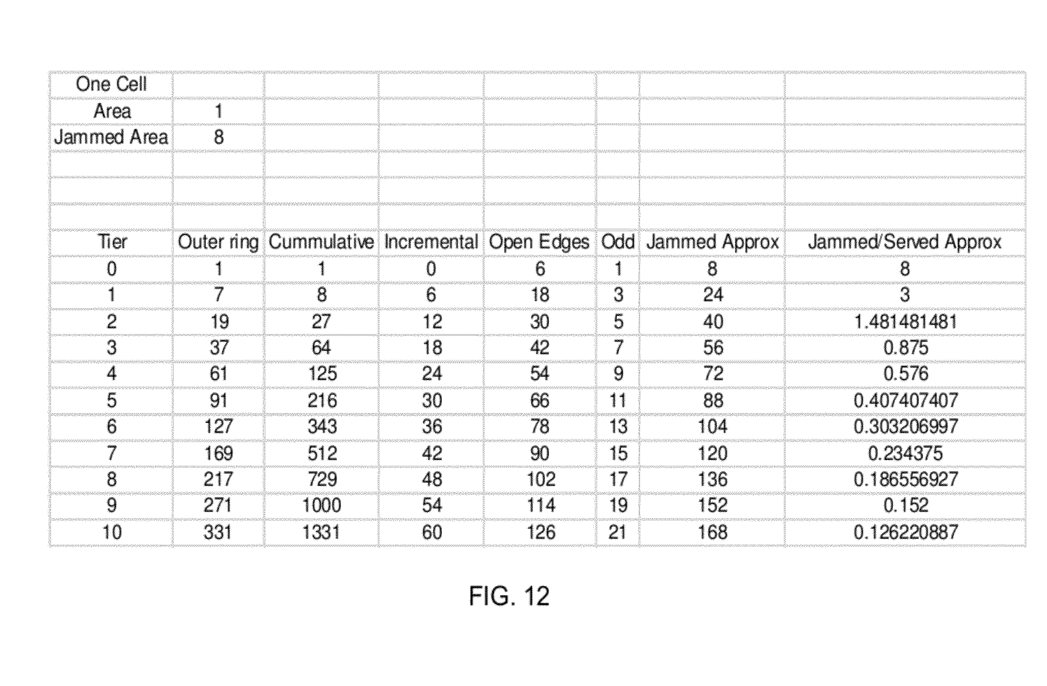

The advantages in terms of reductions in the amount of jammed areas extending beyond the served areas are also illustrated in the calculations summarized in FIGS. 11-13. For example, FIG. 11 lists results of a simple calculation of the number of served area cells and the number of cells along the periphery of a market in which a central transmitter is surrounded by a number of rings (“Tier”). This calculation is a simple matter of geometry, but the table illustrates how the ratio of cells located on the periphery of the market to the total number of cells decreases as the number of total cells increases. FIG. 12 builds on the results of FIG. 11 to estimate the ratio of the jammed area to the served area, as those terms are defined above with reference to FIG. 9. This estimation works from the assumption that a hexagonal cell has 8/6 jammed area per open edge, and uses this approximation to estimate the interference area. This approximation double counts areas that have overlapping coverage from multiple opened edges, but ignores the SFN gain for the interference in the overlapping areas, resulting in partially offsetting assumptions. As the rightmost column in FIG. 12 illustrates, as the number of total low-power, low-site transmitters within the market exceeds 1000 (as may be the case in large metropolitan areas when broadcast transmitters are co-located with cellular and network sites), the jammed area surrounding the served area drops to less than 15% of the total served area. Thus, in such large-scale deployments of low-power, low-site networks, the jammed area will be reduced to a thin ring surrounding a market. FIG. 13 tabulates results of calculations of the slope of the signal level as a function of radius to meet the approximate 8:1 served versus jammed region ratio.

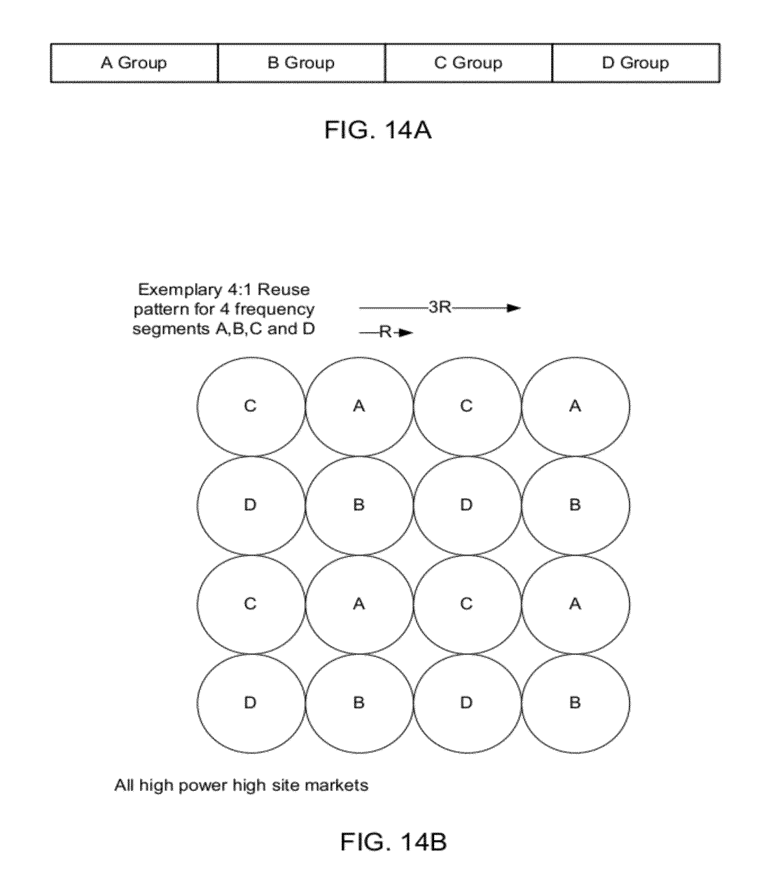

FIG. 14A illustrates a example of a 4:1 frequency reuse allocation plan with frequency blocks identified by letters A, B, C, and D. FIG. 14B illustrates an idealized rectangular array of broadcast markets implementing the frequency allocation plan illustrated in FIG. 14A in high power high site broadcast networks. As this figure illustrates, in a close pack staggering of markets, a 4:1 frequency reuse scheme is possible, since each market can be separated by at least three times the market radius any other market that is reusing the same assigned frequency blocks. This separation distance precludes interference from adjacent markets sharing the same frequency block. In other words, in a high-power, high-site network architecture, each market will be surrounded by markets using different group of frequency blocks. In this manner, if each market has a radius R, then markets using the same frequency group will be separated by a distance of 3R as illustrated.

Using the embodiments described herein, greater frequency utilization may be achieved by deploying low-power, low-site networks in some markets, particularly those in which there is high demand for bandwidth. As described above, the low-power, low-site architecture increases bandwidth utilization by minimizing the area around each market that is subject to jamming from the assigned frequency blocks. In this manner, adjacent markets that would normally jam each other within a given allocated frequency band may be allocated in two adjacent markets that operate in the low-power, low-site architecture. This effectively doubles the available bandwidth in both markets, since previously present co-channel jamming in adjacent markets is eliminated or reduced to manageable levels.

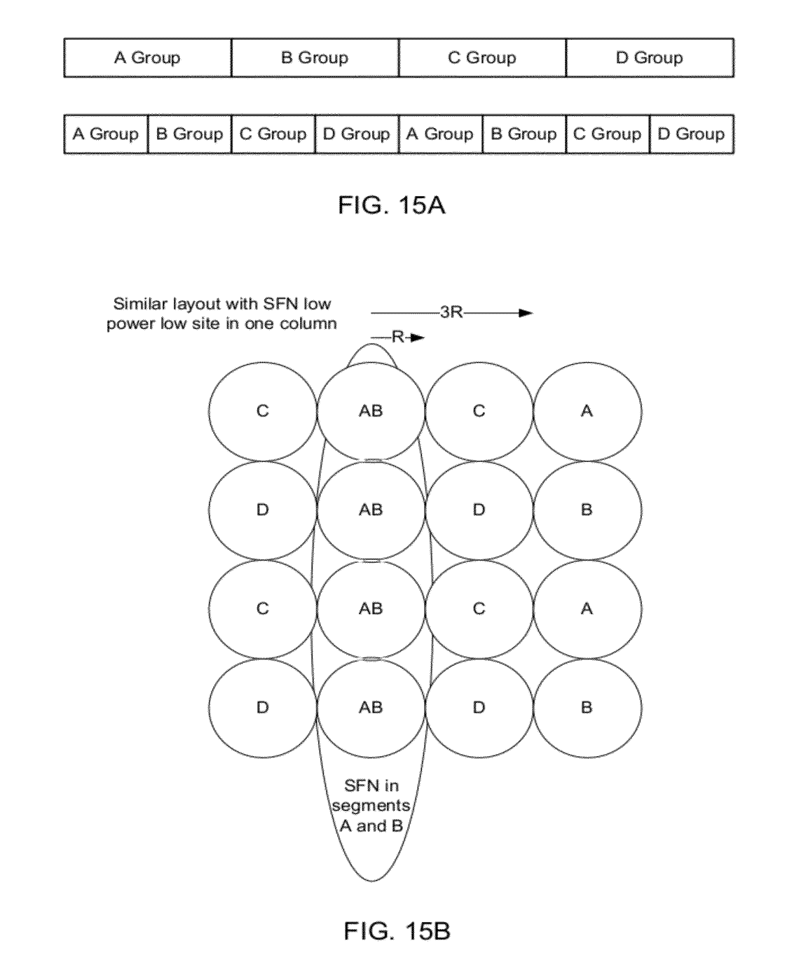

A frequency allocation scheme that may be utilized to implement the embodiments is illustrated in FIG. 15A, which shows frequency a rectilinear array of markets configured with either for high-power networks, as illustrated in FIG. 14A, or low-power networks. Using this frequency allocation scheme in low-power, low-site networks can enable the employing two frequency groups within the same market, thereby doubling the available bandwidth in the markets, without creating interference between adjacent markets due to their reduced radius of jamming. Thus, in a rectangular market organization like that illustrated in FIG. 14B, a column of adjacent markets may be assigned to frequency groups without conflicting as illustrated in FIG. 15B. In this manner, markets addressing high density population centers where bandwidth will be a premium may be assigned to frequency groups if the low-power, low-site network architecture is employed. Other markets may then implement the conventional high-power, high site architecture as illustrated in FIG. 14B. It should be noted, that the 4:1 frequency planning requirement for separating markets from high-power networks employing the same frequency bands is maintained.

It should be noted that while the adjacent markets can share the same two frequency bands (e.g., A and B); the local content will still be distributed only to the home market. Thus, the programming broadcast into adjacent markets may be different even though the allocated frequency bands are the same.

The positioning of conventional high-power, high site network market markets adjacent to the low-power, low-site architecture markets may be a common occurrence because the added cost and necessary infrastructure of the latter architecture is only justified are required in high density markets, such as major cities and population centers. Typically, large population centers are adjacent to rural areas, where the lower population density means there is our fewer bandwidth users and less cellular infrastructure to utilize. Thus, the arrangement illustrated in FIG. 14B may be implemented along the East or West coasts of the United States, where high population centers and established cellular networks are positioned along the coast, but adjacent markets are more rural or undeveloped, where conventional high-power broadcast systems make the most sense.

The various embodiments may also be implemented with frequency allocation schemes other than 4:1, such as N:1 where N is a number between 3 and 6, although larger frequency allocation schemes may be used.

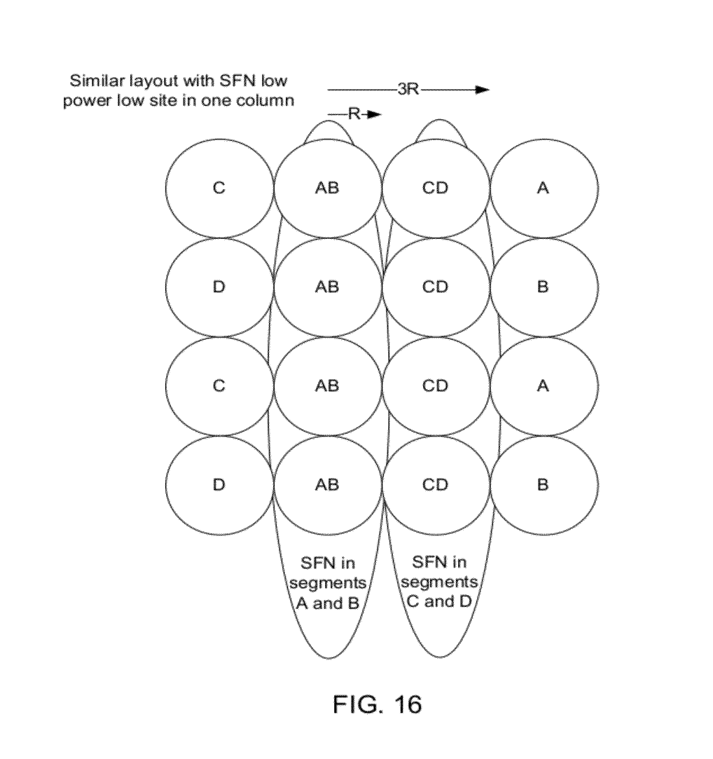

FIG. 16 illustrates another frequency allocation scheme that could be implemented using the low-power, low-site architecture within two columns in a rectilinear market structure. In this case, frequency blocks C and D may be used in a column of markets which are adjacent to high-power markets assigned frequency blocks capital A and B. Thus, the frequency allocation scheme illustrated in FIG. 16 enable us a larger deployment of low-power, low-site network configurations without the joining a high-power, high site markets with a same frequency block.

Implementing the various embodiments involving a low-power, low-site architecture may require a signal conversion scheme involving the use of adapter boxes in markets that convert from high-power television to low-power television in order to convert enhanced eMBMS signals that are received into HDMI outputs that can be processed by televisions. Alternatively, a straight Internet protocol (IP) interface may be provided when IEEE standard H.265 is implemented within television sets. Such adapter boxes may be configured to provide interactive services via an IP interface to the television by one of a wired and a wireless interface. Some adapter boxes may provide both HDMI and IP interfaces. The adapter box may include an advanced codec relative to current high power high tower broadcast format to reduce bandwidth consumed by broadcast programming in the market. The situation in which the adapter box has to support H.265 is transitory assuming that the revised ATSC (or other existing) TV broadcast format includes the more efficient codec. It is also possible for the new or revised standard to contain the aspects of LTE or other land mobile based format that is used in the dense areas.

By merging two frequency bands within a low-power, low-site architecture market, the available bandwidth can be increased by 100%, thereby increasing the nominal bandwidth by a factor of two. The broadcast content in adjoining markets is nevertheless dissimilar, so frequency allocations and market sizing must be allocated to avoid jamming. However, the reduced jamming area associated with a low-power, low-site architecture in the reduced significantly. For example, in contrast to a conventional high-power, high site network in which the jammed area is approximately 8 times the size of the served area (as explained in more detail below), the jammed area surrounding a market employing the low-power, low-site architecture with a large number of transmitters (e.g., 200 or more as is typical in a major Metropolitan market), the jammed area may be reduced to 0.14 times the total served area. Thus, the total area surrounding the market that cannot be served by low-power, low-site transmitters due to jamming from adjacent markets is a small fraction of the total market size (e.g., ˜14% of the total served land mass area). Thus, by deploying low-power, low-set site networks in adjoining markets, broadcasters can be allocated half of the available bandwidth without interfering with each other, except for small regions between the two markets. All of the rest of the bandwidth may then be available for other users. This effectively creates 100% more frequency spectrum available for a variety of communication purposes while enabling the same broadcast coverage in the existing markets.

It should be noted that the low-power, low-site network infrastructure already exists in cellular telephone networks. Thus, broadcasters may place their transmitters on the same towers that already exist for cellular networks. Since the deployment of broadcast systems implementing this low-power, low-site will make available significant frequency bandwidth for other users, mobile network operators (MNO) may be willing to share their transmission sites with television broadcasters in exchange for access to a fraction of this freed up bandwidth. For example, if there are ten 6 MHz stations in each market, this architecture may make available a total of 120 MHz for the combination of television and other general purpose communications.

Implementing the low-power, low-site networks may enable higher capacity modes to be added to cellular networks to minimize the bandwidth consumed by the broadcast components. This is due in part to the differences in the terminal characteristics of fixed receivers, such as conventional televisions, compared to mobile receivers. In particular, fixed receivers configured to receive broadcast television are likely to have a large antenna positioned on the roof. The size and location of fixed receiver antennas results in significant antenna gain, as well as reduced transmission losses since received signals do not have to pass through building structures. In contrast, mobile devices typically have low gain antennas and thus do not receive the benefit of significant antenna gain. Also, mobile receivers are typically at ground level within buildings, and thus must receive signals attenuated by building structures. In order to accommodate these differences, the transmitted signals may be modified to include longer cyclic prefixes due to the increased SINR required, and the increased height, antenna gain and lack of penetration loss for fixed broadcast signals.

The low-power, low-site with aggregated frequency groups architecture may using Orthogonal Frequency Division Multiplex (OFDM) waveforms, including Long Term Evolution (LTE) cellular communication wave forms. The spectrum may also be used to transmit signals according to time division multiplexing (TDM) of land mobile and fixed reception formats.

When a low-power, low-site architecture is deployed in an LTE cellular communication system, the new carriers enabled by the newly available bandwidth may be deployed as paired spectrum for bidirectional LTE communications. Alternatively, the new bandwidth may be operated as a supplemental downlink or carrier aggregation to supplement established cellular communications spectrum, such as paired with other frequency bands, including possibly outside of broadcast bands, to support bidirectional LTE communications. Additionally, broadcast television may be mixed in with the mixed use of the newly available bandwidth. For example, mixed use spectrum may be used to communicate both LTE and other wave forms, such as by using wave forms configured so that cellular telephones receive the signals they are recognized as LTE signals, but at other times the waveforms are incompatible with the LTE protocol. In an embodiment, the radio frequency users may transmit signals configure so that the structural components of LTE protocol waveforms are maintained such that when cellular telephones receive the signals they are recognized as LTE signals, but at other times the waveforms are incompatible with the LTE protocol.

In a low-power, low-site architecture market, television sets equipped with a terminal adapter may be configured to utilize paired spectrum to enable interactive services with existing television terminals. This capability may potentially allow wireless operators to obtain a revenue stream via the reverse communication link traffic, which may be part of the quid pro quo for allowing broadcasters to piggyback on their existing cellular transmission sites.

The use of LTE Evolved Multicast Broadcast Multimedia Service (eMBMS) would also allow distribution of broadcast television content to mobile receiver devices on lower capacity modes at lower bit rates. This broadcast may be provided as part of the services offered in exchange for permitting broadcasters to piggyback broadcast transmitters on existing cellular transmission sites.

Implementing the embodiments of combined frequencies from single transmitters and low-power, low-site networks can group five 6 MHz channels together as described above results in 30 MHz of frequency. Three 10 MHz LTE channels can fit inside this frequency block. This enables the spectrum to be organized market-by-market into groups which can be turned on and off in given markets, which jams the spectrum in those groups but leaves 75% of the spectrum potentially available for other uses.

The various embodiments provide an attractive frequency duplex capability. This is because the wide guard band enabled by grouping the transmission bands together, and using their respective guard bands as wider combined guard bands, provides greater frequency spacing between the reception bands. For example, an embodiment with enable as much as 25-30 MHz in the duplexer bandwidth. This wider duplexer gap provides design benefits in terms of the filters that can be used in the communication devices.

The various embodiments enable the use of existing technology filters in receiver devices. The various embodiments include methods for allocating frequencies in a multi-frequency broadcast network involving allocating adjacent broadcast frequencies in a broadcast group to a plurality of broadcasters transmitting from a common transmission location, and allocating guard bands to the outer edges of the broadcast group. The method may further include removing guard bands between each of the adjacent broadcast frequencies when the broadcasters are transmitting OFDM broadcast signals. The method may further include statistical multiplexing across multiple segments within the broadcast group. The method may further include use of layered coding to enable the multi segment utilizations with a requirement of multi-segment receivers to receive the entire signal, or single segment receiver to receive the base signal. The method may further include organizing frequency groups and segments to reduce adjacent channel filtering complexity in receiver devices. The method may further include using upper and lower band as an FDD pair with favorable duplex separation. The method may further include broadcasting from a large number of lower-height transmission sites at lower power in a given market in order to minimize the jammed area surrounding the market.

Also, the embodiments include a communication system including a transmitter site, and a plurality of broadcasters transmitting from the transmitter site, in which the broadcasters are allocated adjacent broadcast frequencies in a broadcast group to a plurality of broadcasters transmitting from a common transmission location, and guard bands are allocated to the outer edges of the broadcast group. The embodiments also include communication systems in which the market includes a large number of such transmitter sites, with the broadcasts being made at relatively low power (compared to conventional high-power broadcast television) with the transmission antenna being positioned at a relatively low height above the ground (compared to conventional tall broadcast television transmitter sites). The embodiments may also include means for accomplishing the method functions.

The embodiments also include a number of further enhancements to methods of planning and deploying broadcast networks. The embodiment methods may further include applying higher efficiency video coding to maintain or increase broadcast channels (services) while reducing the aggregate baseband bandwidth consumed by such services. The embodiment methods may further include utilizing the increased spectrum using a method selected from the group of supplemental downlinks, carrier aggregation and multiple carrier methods. The embodiment methods may further include grouping contiguous and/or non-contiguous frequency groups and segments into extension carrier and applying carrier aggregation technique. The embodiment methods may further include using low site low power spectrum in an FDD pairing scheme. The embodiment methods may further include organizing markets so that high density markets in an irregular plan receive more capacity (e.g. CD for FDD or BC for downlink only).

The embodiments also include enhancement to communication systems using the foregoing embodiments. The communication systems may include A communication system, a first market having a first plurality of transmitter sites comprising antennas located at a relatively low height and configured to operate at a relatively low power compared to conventional broadcast television broadcast antennas, and a first plurality of broadcasters transmitting from each transmitter site, wherein the first plurality of broadcasters are allocated adjacent broadcast frequencies in a plurality of broadcast groups to the first plurality of broadcasters transmitting from common transmission locations. In some embodiments, guard bands may be allocated to the outer edges of the broadcast group. In some embodiments the communication system may further include a second market positioned approximately adjacent to the first market and including a second plurality of transmitter sites comprising antennas located at a relatively low height and configured to operate at a relatively low power compared to conventional broadcast television broadcast antennas, and a second plurality of broadcasters transmitting from each transmitter site, wherein the second plurality of broadcasters are allocated the same adjacent broadcast frequencies in a same plurality of broadcast groups as in the first market to the second plurality of broadcasters transmitting from common transmission locations. Low-power, low-site markets need not be adjacently only to one another, and in some embodiments the communication system may further include a second market positioned approximately adjacent to the first market and include a single high height, high power broadcast television transmitter site, and a second plurality of broadcasters transmitting from the single high height, high power transmitter site, wherein the second plurality of broadcasters are allocated adjacent broadcast frequencies in plurality of broadcast groups different from those in the first market to the second plurality of broadcasters transmitting from the broadcast television transmitter.

The embodiments are not limited to broadcast television. In a further embodiment a communication system may include a plurality of transmitter sites comprising antennas located at a relatively low height and configured to operate at a relatively low power compared to conventional broadcast television broadcast antennas, and a plurality of radio frequency users transmitting from each transmitter site, wherein the plurality of radio frequency users are allocated adjacent broadcast frequencies in a plurality of frequency groups to the plurality of radio frequency users transmitting from common transmission locations. In a further embodiment of such a communication system, the plurality of radio frequency users transmit signals using Orthogonal Frequency Division Multiplex (OFDM) waveforms. In a further embodiment of such a communication system, the plurality of radio frequency users may transmit signals according to the Long Term Evolution protocol. In a further embodiment of such a communication system, the plurality of radio frequency users may transmit signals configure so that the structural components of LTE protocol waveforms are maintained such that when cellular telephones receive the signals they are recognized as LTE signals, but at other times the waveforms are incompatible with the LTE protocol. In a further embodiment of such a communication system, the plurality of radio frequency users may transmit signals according to time division multiplexing (TDM) of land mobile and fixed reception formats. In a further embodiment of such a communication system, the allocated adjacent broadcast frequencies may be grouped into contiguous and/or non-contiguous frequency groups and segments. In a further embodiment of such a communication system, the contiguous and/or non-contiguous frequency groups and segments may be accomplished by applying carrier aggregation techniques. In a further embodiment of such a communication system, bandwidth liberated by transmitting from low-power, low-site sites and aggregating the adjacent broadcast frequencies into a plurality of frequency groups may be used for uplink communications, downlink communications, or both uplink and downlink communications. In an embodiment, control channels may be organized separately instead of jointly.

In a further embodiment, a low-power, low-site frequency aggregated communication system may further include a plurality of adapter boxes coupled to a plurality of televisions and configured to enable reception of broadcast signals from the plurality of low-power, low-site transmitters by the plurality of televisions, wherein the plurality of adapter boxes are coupled to the plurality of televisions by an interface selected from an HDMI interface, an IP interface, and both an HDMI and IP interface. In a further embodiment, such a communication system may further include a plurality of adapter boxes coupled to a plurality of televisions and configured to enable reception of broadcast signals from the plurality of low-power, low-site transmitters by the plurality of televisions, wherein the plurality of adapter boxes comprise an advanced codec relative to current high power high tower broadcast format to reduce bandwidth consumed by broadcast programming in the market. In a further embodiment of such a communication system, a plurality of adapter boxes coupled to a plurality of televisions and configured to enable reception of broadcast signals from the plurality of low-power, low-site transmitters by the plurality of televisions may include conventional codecs if the broadcast formats of the plurality of radio frequency users broadcast using formats upgraded to contain advanced codecs. In a further embodiment of such a communication system, the plurality of adapter boxes coupled to a plurality of televisions and configured to enable reception of broadcast signals from the plurality of low-power, low-site transmitters by the plurality of televisions may be configured to provide interactive services via an IP interface to the television by one of a wired and a wireless interface.

Embodiment communication systems may further include means for applying higher efficiency video coding to maintain or increase broadcast channels (services) while reducing the aggregate baseband bandwidth consumed by such services. Embodiment communication systems may further include means for utilizing the increased spectrum using a method selected from the group of supplemental downlinks, carrier aggregation and multiple carrier methods. Embodiment communication systems may further include means for grouping contiguous and/or non-contiguous frequency groups and segments into an extension carrier and applying carrier aggregation technique. Embodiment communication systems may further include means for using low site low power spectrum in an FDD pairing scheme. Embodiment communication systems may further include means for supporting irregular frequency plans comprising different groupings of broadcast channels that are not uniform for each instance of frequency groups. Embodiment communication systems may further include a plurality of receiver devices, wherein the plurality of receiver devices include means for enhancing usable bandwidth of irregular frequency via multiple frequency group filters. In embodiment communication systems the means for allocating adjacent broadcast frequencies in a broadcast group to a plurality of broadcasters transmitting from each of the plurality of transmitter sites may include means for organizing markets so that high density markets in an irregular plan receive more capacity (e.g. code division multiplexing for FDD or broadcast for downlink only).

Further embodiments include a communication system that includes a plurality of transmitter sites having antennas located at a relatively low height and configured to broadcast at a relatively low power compared to conventional broadcast television broadcast antennas, and means for allocating adjacent broadcast frequencies in a carrier aggregated continuous spectrum broadcast group to a plurality of broadcasters transmitting from each of the plurality of transmitter sites. Embodiment communication systems may further include means for allocating guard bands to outer edges of the broadcast group. Embodiment communication systems may further include means for enabling higher efficiency modulation schemes within existing land mobile formats using higher order constellations that can be supported for mobile communications. Embodiment communication systems may further include means for enabling higher efficiency modulation schemes within existing land mobile formats using fixed reception specific mixed input/mixed output (MIMO) configurations. Embodiment communication systems may further include means for using hierarchical modulation with fixed reception on upper layers and land mobile on lower layers.

Embodiment communication systems may further include means for separately time division multiplexing (TDM) of the fixed reception component as compared to land mobile organization. Embodiment communication systems may further include means for separating communication of fixed reception organization from land mobile by means of TDM access, in which control channels may be organized separately instead of jointly. Embodiment communication systems may further include means for including joint communication of organization access for fixed and land mobile reception. Embodiment communication systems may further include means for sharing the spectrum made available by a combination of frequency planning and deployment style changes between broadcast and unicast applications. Embodiment communication systems may further include means for applying higher efficiency video coding to maintain or increase broadcast channels while reducing the aggregate baseband bandwidth consumed by such services. Embodiment communication systems may further include means for utilizing the increased spectrum using a method selected from the group of supplemental downlinks, carrier aggregation and multiple carrier methods.

Embodiment communication systems may further include means for grouping contiguous and/or non-contiguous frequency groups and segments into extension carrier and applying carrier aggregation techniques. Embodiment communication systems may further include means for using low site low power spectrum in a frequency-division duplexing (FDD) pairing scheme. Embodiment communication systems may further include means for supporting irregular frequency plans comprising different groupings of broadcast channels that are not uniform for each instance of frequency groups. Embodiment communication systems may further include a plurality of a receiver devices that include means for enhancing usable bandwidth of irregular frequency via multiple frequency group filters. In the communication system the means for allocating adjacent broadcast frequencies in a broadcast group to a plurality of broadcasters transmitting from each of the plurality of transmitter sites may include means for organizing markets so that high density markets in an irregular plan receive more capacity, such as code division multiplexing for frequency-division duplexing (FDD) or broadcast for downlink only.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more computer-executable or processor-executable instructions or code on a non-transitory computer-readable or processor-readable storage medium. The steps of a method or algorithm disclosed herein may be embodied in a processor-executable software module executed which may reside on a non-transitory computer-readable storage medium. Non-transitory computer-readable and processor-readable storage media include any form of computer storage media. A non-transitory storage media may be any available media that may be accessed by a computer or processor. By way of example, and not limitation, such non-transitory computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc, laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable and processor-readable storage media. Additionally, the operations of a method or algorithm may reside as one or any combination or set of codes and/or instructions on a non-transitory computer-readable and non-transitory processor-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein, but is to be accorded the widest scope consistent with the following claims and the principles and novel features disclosed herein.

What is claimed is:

1. A method of allocating frequencies in a multi-frequency broadcast network, comprising:
aggregating a number of broadcast frequencies into a continuous spectrum block comprising a broadcast group and allocating adjacent broadcast frequencies in the broadcast group to a plurality of broadcasters transmitting from a common transmission location or a virtually collocated transmission location.

2. The method of claim 1, further comprising creating more than one group of frequencies within a single market.

3. The method of claim 1, further comprising allocating guard bands to outer edges of the broadcast group.

4. The method of claim 3, further comprising removing internal guard bands between each of the adjacent broadcast frequencies when the plurality of broadcasters are transmitting Orthogonal Frequency Division Multiplex (OFDM) broadcast signals or other modulation schemes that are capable of operating with a zero guard band which are mutually orthogonal on a per signal basis.

5. The method of claim 1, further comprising applying statistical multiplexing across multiple segments within the broadcast group.

6. The method of claim 1, further comprising using layered media coding to enable multi segment utilization with a requirement of multi-segment receivers to receive an entire signal or a single segment receiver to receive only a base signal.

7. The method of claim 1, further comprising organizing frequency groups and segments to reduce adjacent channel filtering complexity in receiver devices.

8. The method of claim 1, wherein frequencies are allocated in an N-to-one (N:1) frequency reuse scheme, wherein N is a number between three and six.

9. The method of claim 1, further comprising using upper and lower frequency regions that may be utilized as an frequency-division duplexing (FDD) pair with favorable duplex separation.

10. The method of claim 9, further comprising transmitting signals of the plurality of broadcasters at relatively low power from a plurality of common transmission locations at relatively low antenna height within a second market approximately adjacent to a first market.

11. The method of claim 2, further comprising transmitting signals within a plurality of frequencies groups at relatively low power from a plurality of common transmission locations at relatively low antenna height within a first market.

12. The method of claim 11, further comprising utilizing a first group of frequencies within the first market for television broadcast service, and a second group of frequencies within the first market for uses other than television broadcast.

13. The method of claim 11, further comprising applying higher efficiency video coding to maintain or increase broadcast channels while reducing aggregate baseband bandwidth consumed by such services.

14. The method of claim 11, further comprising utilizing increased spectrum using a method selected from the group of supplemental downlinks, carrier aggregation and multiple carrier methods.

15. The method of claim 11, further comprising grouping one or both of contiguous and non-contiguous frequency groups and segments into one of supplemental downlinks and carrier aggregation.

16. The method of claim 11, further comprising using low site low power spectrum in a frequency-division duplexing (FDD) pairing scheme.

17. The method of claim 11, further comprising organizing markets so that high density markets in an irregular plan receive more capacity.

18. The method of claim 11, wherein each of the plurality of frequency groups are used for mixed communication services which may contain television broadcast transmissions in a different waveform.

19. The method of claim 18, wherein the television broadcast transmissions are mixed with one or both of cellular telephone transmissions and mobile broadband.

20. A communication system, comprising:
a transmitter site; and
a plurality of broadcasters transmitting from the transmitter site, wherein the plurality of broadcasters are allocated adjacent broadcast frequencies in a carrier aggregated continuous spectrum broadcast group.

21. The communication system of claim 20, wherein guard bands are allocated to outer edges of the broadcast group.

22. A communication system, comprising:
a first market comprising:
a first plurality of transmitter sites comprising antennas located at a relatively low height and configured to operate at a relatively low power compared to conventional broadcast television broadcast antennas; and
a first plurality of broadcasters transmitting from each transmitter site, wherein the first plurality of broadcasters are allocated adjacent broadcast frequencies in a carrier aggregated continuous spectrum plurality of broadcast groups.

23. The communication system of claim 22, wherein guard bands are allocated to outer edges of the broadcast group.

24. The communication system of claim 22, further comprising a second market positioned approximately adjacent to the first market and comprising:
a second plurality of transmitter sites comprising antennas located at a relatively low height and configured to operate at a relatively low power compared to conventional broadcast television broadcast antennas; and
a second plurality of broadcasters transmitting from each transmitter site, wherein the second plurality of broadcasters are allocated the same adjacent broadcast frequencies in a same plurality of broadcast groups as in the first market transmitting from common transmission locations.

25. The communication system of claim 22, further comprising a second market positioned approximately adjacent to the first market and comprising:
a single high height, high power broadcast television transmitter; and
a second plurality of broadcasters transmitting from the single high height, high power transmitter site, wherein the second plurality of broadcasters are allocated adjacent broadcast frequencies in a plurality of broadcast groups different from those in the first market transmitting from the broadcast television transmitter.

26. A communication system, comprising:
a plurality of transmitter sites comprising antennas located at a relatively low height and configured to operate at a relatively low power compared to conventional broadcast television broadcast antennas; and
a plurality of radio frequency users transmitting from each transmitter site, wherein the plurality of radio frequency users are allocated adjacent broadcast frequencies in a carrier aggregated continuous spectrum plurality of frequency groups transmitting from common transmission locations.

27. The communication system of claim 26, wherein the plurality of radio frequency users transmit signals using Orthogonal Frequency Division Multiplex (OFDM) waveforms.

28. The communication system of claim 26, wherein the plurality of radio frequency users transmit signals according to the Long Term Evolution protocol.

29. The communication system of claim 26, wherein the plurality of radio frequency users transmit signals configure so that the structural components of Long Term Evolution (LTE) protocol waveforms are maintained such that when cellular telephones receive the signals they are recognized as LTE signals, but at other times signal waveforms are incompatible with the LTE protocol.

30. The communication system of claim 26, wherein the allocated adjacent broadcast frequencies are grouped into one or both of contiguous and non-contiguous frequency groups and segments.

31. The communication system of claim 26, wherein the plurality of radio frequency users transmit signals according to time division multiplexing (TDM) of land mobile and fixed reception formats.

32. The communication system of claim 31, wherein the plurality of radio frequency users transmit signals separate communication of fixed reception organization from land mobile communications by means of TDM access.

33. The communication system according to claim 32, wherein control channels are organized separately instead of jointly.

34. The communication system of claim 31, wherein bandwidth liberated by transmitting from low-power, low-site sites and aggregating the adjacent broadcast frequencies into a plurality of frequency groups is used for uplink communications, downlink communications, or both uplink and downlink communications.

35. The communication system of claim 31, further comprising:
a plurality of adapter boxes coupled to a plurality of televisions and configured to enable reception of broadcast signals from the plurality of low-power, low-site transmitters by the plurality of televisions, wherein the plurality of adapter boxes are coupled to the plurality of televisions by an interface selected from an high-definition multimedia interface (HDMI) interface, an Internet protocol (IP) interface, and both an HDMI and IP interface.

36. The communication system of claim 31, further comprising:
a plurality of adapter boxes coupled to a plurality of televisions and configured to enable reception of broadcast signals from the plurality of low-power, low-site transmitters by the plurality of televisions, wherein the plurality of adapter boxes comprise an advanced codec relative to current high power high tower broadcast format to reduce bandwidth consumed by broadcast programming.

37. The communication system of claim 31, further comprising a plurality of a receiver devices comprising multiple frequency group filters, wherein the multiple frequency group filters are configured to enhance usable bandwidth of irregular frequency signals.

38. The communication system of claim 31, further comprising:
a plurality of adapter boxes coupled to a plurality of televisions and configured to enable reception of broadcast signals from the plurality of low-power, low-site transmitters by the plurality of televisions, wherein the plurality of adapter boxes comprise conventional codecs,
wherein broadcast formats of the plurality of radio frequency users broadcast using formats upgraded to contain advanced codecs.

39. The communication system of claim 38, further comprising:
a plurality of adapter boxes coupled to a plurality of televisions and configured to enable reception of broadcast signals from the plurality of low-power, low-site transmitters by the plurality of televisions, wherein the plurality of adapter boxes are configured to provide interactive services via an IP interface to the television by one of a wired and a wireless interface.

40. A communication system, comprising:
means for aggregating a number of broadcast frequencies into a continuous spectrum block comprising a broadcast group and allocating adjacent broadcast frequencies in the broadcast group to a plurality of broadcasters transmitting from a common transmission location.

41. The communication system of claim 40, further comprising means for allocating guard bands to outer edges of the broadcast group.

42. A communication system, comprising:
a plurality of transmitter sites comprising antennas located at a relatively low height and configured to broadcast at a relatively low power compared to conventional broadcast television broadcast antennas; and
means for allocating adjacent broadcast frequencies in a carrier aggregated continuous spectrum broadcast group to a plurality of broadcasters transmitting from each of the plurality of transmitter sites.

43. The communication system of claim 42, further comprising means for allocating guard bands to outer edges of the broadcast group.

44. The communication system of claim 42, further comprising means for enabling higher efficiency modulation schemes within existing land mobile formats using higher order constellations that can be supported for mobile communications.

45. The communication system of claim 42, further comprising means for enabling higher efficiency modulation schemes within existing land mobile formats using fixed reception specific mixed input/mixed output (MIMO) configurations.

46. The communication system of claim 42, further comprising means for using hierarchical modulation with fixed reception on upper layers and land mobile on lower layers.

47. The communication system of claim 46, further comprising means for separately time division multiplexing (TDM) of fixed reception component as compared to land mobile organization.

48. The communication system of claim 42, further comprising means for separating communication of fixed reception organization from land mobile by means of TDM access.

49. The communication system according to claim 48, wherein control channels are organized separately instead of jointly.

50. The communication system of claim 42, further comprising means for including joint communication of organization access for fixed and land mobile reception.

51. The communication system of claim 42, further comprising means for sharing spectrum made available by a combination of frequency planning and deployment style changes between broadcast and unicast applications.

52. The communication system of claim 42, further comprising means for applying higher efficiency video coding to maintain or increase broadcast channels while reducing aggregate baseband bandwidth consumed by such services.

53. The communication system of claim 42, further comprising means for utilizing increased spectrum using a method selected from the group of supplemental downlinks, carrier aggregation and multiple carrier methods.

54. The communication system of claim 42, further comprising means for grouping contiguous and/or non-contiguous frequency groups and segments into extension carrier and applying carrier aggregation techniques.

55. The communication system of claim 42, further comprising means for using low site low power spectrum in an frequency-division duplexing (FDD) pairing scheme.

56. The communication system of claim 42, further comprising means for supporting irregular frequency plans comprising different groupings of broadcast channels that are not uniform for each instance of frequency groups.

57. The communication system of claim 42, further comprising a plurality of a receiver devices, wherein the plurality of receiver devices include means for enhancing usable bandwidth of irregular frequency via multiple frequency group filters.

58. The communication system of claim 42, wherein means for allocating adjacent broadcast frequencies in a broadcast group to a plurality of broadcasters transmitting from each of the plurality of transmitter sites comprises means for organizing markets so that high density markets in an irregular plan receive more capacity, such as code division multiplexing for frequency-division duplexing (FDD) or broadcast for downlink only.
